(19) United States
(12) Patent Application Publication
(10) Pub. No.: US 2009/0029230 A1
(43) Pub. Date: Jan. 29, 2009

(54) Fuel Cell and Fuel Cell Stack

(76) Inventor: Junichi Shirahama, Aichi-ken (JP)

Correspondence Address: KENYON & KENYON LLP, 1500 K STREET N.W., SUITE 700, WASHINGTON, DC, 20005, US

(21) Appl. No.: 11/918,279

(22) PCT Filed: Apr. 14, 2006
(86) PCT No.: PCT/JP2006/307954

§ 371 Date: Nov. 2, 2007

(30) Foreign Application Priority Data
Apr. 14, 2005 (JP) 2005-117241

(51) Int. Cl. H01M 2/08; H01M 2/00

(52) U.S. Cl. 429/35; 429/34

(57) ABSTRACT

A fuel cell stack is prepared by laminating multiple fuel cells. Each fuel cell has a first separator, a first resin frame, a second resin frame, and a second separator arranged in this sequence. A membrane electrode assembly or MEA is held between the two resin frames. A layered structure of the two resin frames and seal layers forms an inter-separator inclusion. In the fuel cell, a barcode is provided on an exposed outer surface of the inter-separator inclusion, which has a greater thickness than those of the respective separators. This arrangement enables the barcode to be readily provided and scanned, regardless of the thicknesses and the materials of the respective separators.

### TECHNICAL FIELD

The present invention relates to a fuel cell and a fuel cell stack.

### BACKGROUND ART

In a known structure of a fuel cell, a membrane electrode assembly (MEA) having an anode and a cathode arranged across a solid electrolyte membrane is interposed between a pair of separators. The technique of Patent Document 1 adoptable in the fuel cell of this structure provides a barcode, which is correlated to information on the fuel cell, on an exposed outer surface of the separator. This arrangement enables the barcode to be readily scanned without disassembly of the fuel cell.

### Patent Document 1: Japanese Patent Laid-Open Application No. 2003-115319

### DISCLOSURE OF THE INVENTION

The technique of Patent Document 1 provides the barcode on the separator. The separator may, however, not be suitable as the location of the barcode. For example, the thin separator has difficulty in application of the barcode. The separator having high hardness has difficulty in marking of the barcode. The separator having high ink or adhesive resistance has difficulty in printing of the barcode.

In a fuel cell and a fuel cell stack, there is a demand of readily providing an information recording element for recording information on the fuel cell, regardless of the thickness and the material of a separator.

At least part of the above and the other related demands is attained by a fuel cell and a fuel cell stack having the configurations discussed below.

According to one aspect, the present invention is directed to a fuel cell including: a pair of separators;

an inter-separator inclusion that is interposed between the pair of separators; and

an information recording element that is provided in the inter-separator inclusion and records information on the fuel cell.

In the fuel cell according to this aspect of the invention, the information recording element is provided not in the separator but in the inter-separator inclusion. This arrangement enables the information recording element to be readily provided, regardless of the thickness and the material of the separators.

The ‘information on the fuel cell’ represents information regarding the fuel cell or any component of the fuel cell and includes, for example, the output characteristic, the use history, the manufacturing information, and the time-course behavior information of the fuel cell, as well as information regarding manufacture (the date of manufacture, the lot number, and the material) of each component of the fuel cell, for example, the separators, the inter-separator inclusion, and a membrane electrode assembly. The ‘information on the fuel cell’ includes a retrieval code correlated to these pieces of information. The ‘information recording element’ may be a print or marking on an exposed surface of the inter-separator inclusion, an information recording medium applied on the exposed surface of the inter-separator inclusion, or an IC chip embedded in the inter-separator inclusion.

In the fuel cell of the invention, it is preferable that the inter-separator inclusion has a greater thickness than those of the separators. In the fuel cell having thin separators, the inter-separator inclusion designed to have the greater thickness than those of the separators enables the information recording element to be readily provided.

In the fuel cell of the invention, it is also preferable that the inter-separator inclusion has a greater flexibility than those of the separators. In the fuel cell having separators of little flexibility and high hardness, the inter-separator inclusion designed to have the greater flexibility enables the information recording element to be readily provided by marking, cutting, or another suitable machining technique. In one example, the separator is made of a metal or carbon base plate, whereas the inter-separator inclusion is made of a resin material.

According to one application of the fuel cell of the invention, the information recording element is set on an outer exposed surface of the inter-separator inclusion. In one preferable embodiment of this application, the inter-separator inclusion has a frame member keeping a membrane electrode assembly, and the exposed surface includes at least a side face of the frame member. The fuel cell of this embodiment has the thin separators and uses the frame member of the thicker inter-separator inclusion as a structural material. This arrangement allows the effective use of the side face of the frame member. The frame member may occupy a large fraction of the inter-separator inclusion. In this case, the thickness of the frame member is set to ensure the sufficient gas flow rates in a fuel gas flow path and an oxidizing gas flow path generally formed between the separators. More specifically the thickness of the frame member is set to ensure the sufficient gas flow rates in the flow paths for efficient electrochemical reaction of a fuel gas and an oxidizing gas. For the insulation between the pair of separators, the frame member is preferably made of an insulating resin material.

In another preferable embodiment of the above application with the information recording element set on the outer exposed surface of the inter-separator inclusion, the inter-separator inclusion has a seal member arranged along an outer circumference of the inter-separator inclusion, and the exposed surface includes at least a side face of the seal member. The fuel cell generally has the fuel gas flow path and the oxidizing gas flow path, which require the sufficient gas tightness. The seal member arranged along the outer circumference of the inter-separator inclusion effectively ensures the gas tightness of these flow paths. This arrangement allows the effective use of the side face of the seal member.

According to another application of the fuel cell of the invention, the information recording element is embedded in the inter-separator inclusion. In one preferable embodiment of this application, the inter-separator inclusion has a frame member keeping a membrane electrode assembly, and the information recording element is embedded in the frame member. The fuel cell of this embodiment has the thin separators and uses the frame member of the thicker inter-separator inclusion as a structural material. This arrangement allows the effective use of the frame member. In another preferable embodiment of this application, the inter-separator inclusion has a seal member arranged along an outer circumference of the inter-separator inclusion, and the information recording element is embedded in the seal member. The fuel cell generally has the fuel gas flow path and the oxidizing gas flow path, which require the sufficient gas tightness. The seal member arranged along the outer circumference of the inter-separator inclusion effectively ensures the gas tightness of these flow paths. This arrangement allows the effective use of the side face of the seal member.

In the fuel cell of the invention, it is preferable that the information recording element records information visually recognizable by the human or information scannable in any of optical, magnetic, electric, and mechanical ways. The information visually recognizable by the human may be information expressed by letters, characters, figures, graphics, and symbols. The optically scannable information may be information recorded in a barcode. The magnetically scannable information may be information recorded in a magnetic tape. The electrically scannable information may be information recorded in an IC chip. The mechanically scannable information may be information recorded as a code pattern of concaves and convexes. The information recording element may be only writable or rewritable.

In one preferable embodiment of the fuel cell of the invention, the pair of separators are made of thin metal plates. This arrangement desirably decreases the overall length of a laminate of multiple fuel cells in its laminating direction and attains the favorable size reduction, while reducing the resistance between adjacent fuel cells and enhancing the power generation efficiency.

According to another aspect, the invention is also directed to a fuel cell stack that is prepared by laminating multiple fuel cells,

wherein the multiple fuel cells include at least one fuel cell having any of above characteristics.

In at least one fuel cell included in the fuel cell stack of the invention, the information recording element is provided on the outer exposed surface of the inter-separator inclusion having the greater thickness than those of the separators. This arrangement enables the information on the fuel cell to be readily scanned from the information recording element in the laminated state of the multiple fuel cells.

In one preferable application of the fuel cell stack of the invention, the multiple fuel cells include two adjacent fuel cells having any of the above characteristics. The respective information recording elements of the two adjacent fuel cells are separated by at least the separators of the two adjacent fuel cells. This arrangement effectively prevents one of the information recording elements of the two adjacent fuel cells from interfering with scan of the other information recording element.

### BRIEF DESCRIPTION OF THE DRAWINGS

FIG. 1 is a perspective view schematically illustrating the structure of a fuel cell stack in one embodiment of the invention;

FIG. 2 is a decomposed perspective view showing the structure of a fuel cell as a unit cell of the fuel cell stack;

FIGS. 3(a) and 3(b) are a top view and a bottom view showing a first separator included in the fuel cell;

FIGS. 4(a) and 4(b) are a top view and a bottom view showing a second separator included in the fuel cell;

FIG. 5 is a sectional view showing the structure of another fuel cell in one modified example;

FIG. 6 is a perspective view showing the structure of sill another fuel cell in another modified example; and

FIG. 7 is a perspective view showing the structure of another fuel cell in still another modified example.

### BEST MODES OF CARRYING OUT THE INVENTION

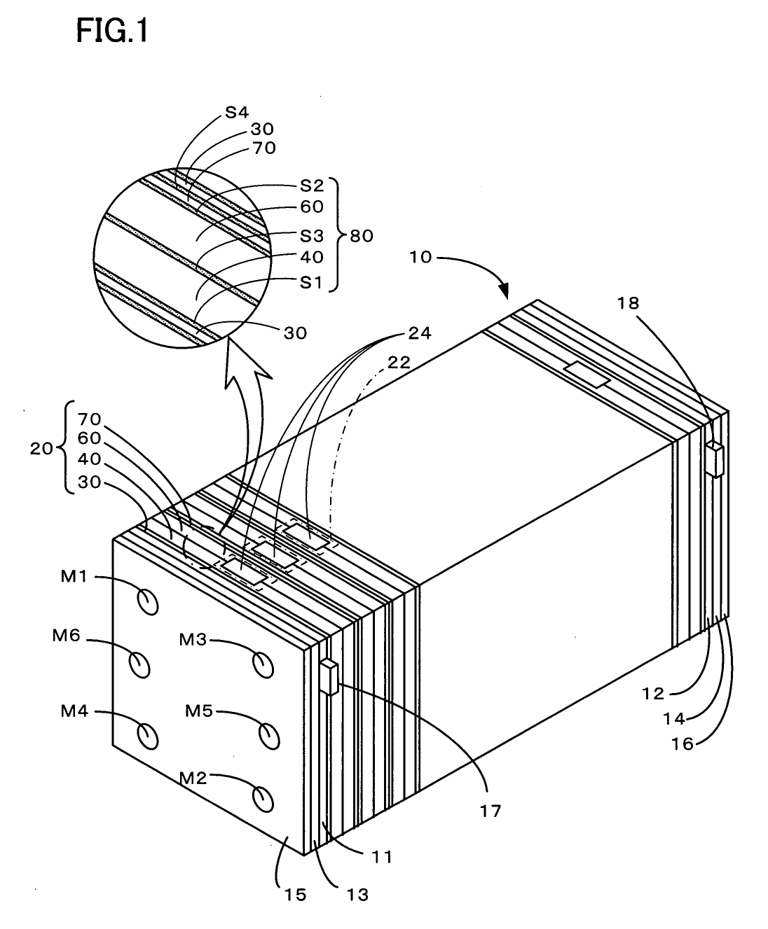

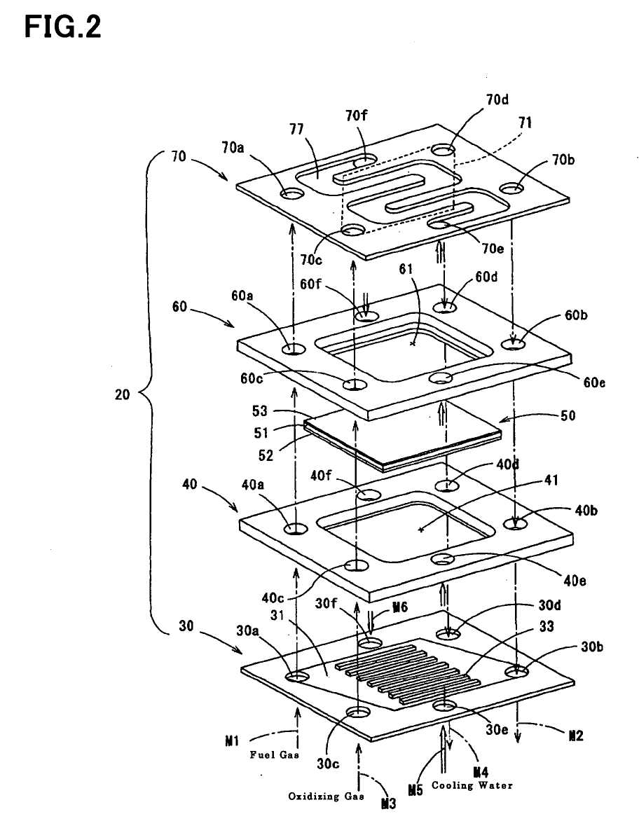

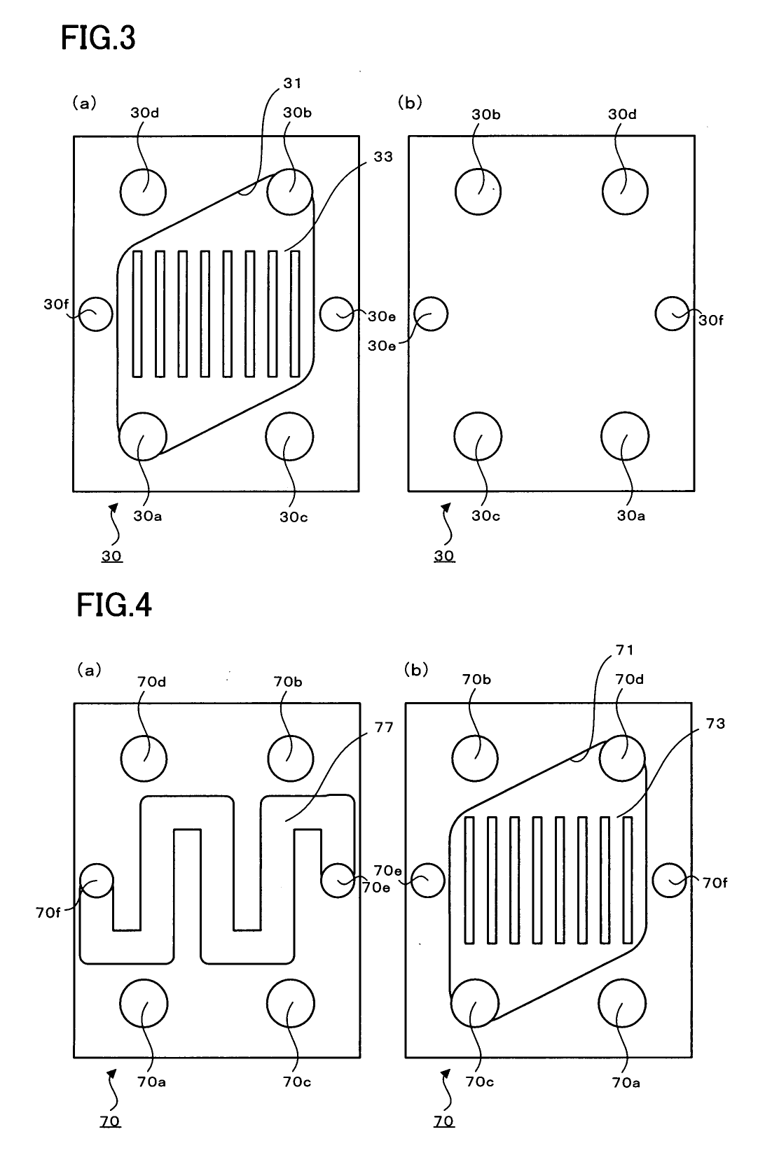

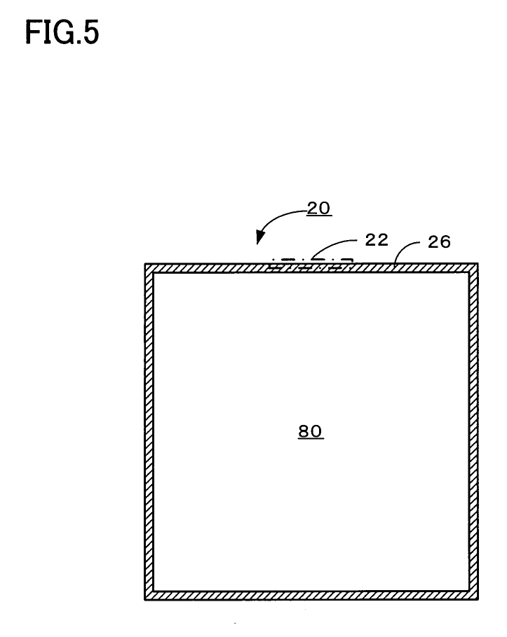

In order to explain the features, the characteristics, and the functions of the invention in detail, some modes of carrying out the invention are described below with reference to the accompanied drawings. FIG. 1 is a perspective view schematically illustrating the structure of a fuel cell stack 10 in one embodiment of the invention. FIG. 2 is a decomposed perspective view showing the structure of a fuel cell 20 as a unit cell of the fuel cell stack 10. FIG. 3 shows the structure of a first separator 30 included in the fuel cell 20. FIG. 4 shows the structure of a second separator 70 included in the fuel cell 20.

The fuel cell stack 10 is constructed as a laminate of multiple fuel cells 20. Hydrogen as a fuel gas is supplied from a hydrogen tank (not shown) into a hydrogen supply manifold M1, flows through the respective fuel cells 20, and is discharged out of a hydrogen exhaust manifold M2. The air (containing oxygen as an oxidizing gas) compressed by an air compressor (not shown) is fed into an air supply manifold M3, flows through the respective fuel cells 20, and is emitted out of an air exhaust manifold M4. Cooling water is introduced from a cooling water tank (not shown) into a cooling water supply manifold M5 by means of a cooling water circulation pump (not shown), goes through the respective fuel cells 20, and is flowed out of a cooling water discharge manifold M6. After heat recovery, the cooling water is recirculated into the cooling water supply manifold M5 by means of the cooling water circulation pump. The respective fuel cells 20 generate electric power by the electrochemical reaction of hydrogen and oxygen that are supplied to the fuel cell stack 10 and flow through the respective fuel cells 20.

The fuel cell stack 10 is completed by sequentially placing power collectors 11 and 12, insulating plates 13 and 14, and end plates 15 and 16 on both ends of the laminate of the multiple fuel cells 20 as shown in FIG. 1. The power collectors 11 and 12 are made of a gas-impermeable conductive material, such as dense carbon or copper plate. The insulating plate 13 and 14 are made of an insulating material, such as a rubber or a resin. The end plates 15 and 16 are made of a rigid metal material, such as steel. The power collectors 11 and 12 respectively have output terminals 17 and 18. One of the output terminals 17 and 18 is connected to a positive electrode, while the other of the output terminals 17 and 18 is connected to a negative electrode. The end plates 15 and 16 hold the fuel cell stack 10 under application of a pressure in its laminating direction by means of a pressure device (not shown). While the end plate 16 has no through hole, the end plate 15 has six through holes, which are openings connecting with the corresponding manifolds M1 to M6.

As shown in FIG. 2, the fuel cell 20 includes a first separator 30, a first resin frame 40, an MEA 50, a second resin frame 60, and a second separator 70 that are placed in this sequence.

The MEA 50 is a membrane-electrode assembly including an anode 52 and a cathode 53 arranged across a solid electrolyte membrane 51. The solid electrolyte membrane 51 is a proton-conductive ion exchange membrane of a solid polymer material, such as a fluororesin (for example, Nafion membrane manufactured by du Pont) and shows favorable proton conductivity in the wet state. The solid electrolyte membrane 51 has catalyst electrode layers formed on its opposed two faces by application of platinum or a platinum alloy and gas diffusion electrode layers formed outside the respective catalyst electrode layers. The gas diffusion electrode layers are made of carbon cloth of carbon fiber yarns. One set of the catalyst electrode layer and the gas diffusion electrode layer provided on one face of the solid electrolyte membrane 51 form the anode 52. The other set of the catalyst electrode layer and the gas diffusion electrode layer provided on the other face of the solid electrolyte membrane 51 form the cathode 53.

The first separator 30 is a thin metal plate member having a thickness in a range of 0.05 mm to 0.3 mm and is obtained by, for example, coating a thin stainless plate base with a conductive film having a higher corrosion resistance than that of the plate base. A recess 31 is formed in an upper face of the first separator 30 or a plane facing the anode 52 of the MEA 50 (see FIG. 3(a)). The recess 31 has a hydrogen flow path 33 to allow passage of hydrogen. The first separator 30 has a flat lower face (see FIG. 3(b)). The first separator 30 has gas flow openings 30a to 30d formed at its four corners and cooling water flow openings 30e and 30f. The gas flow openings 30a and 30b are located inside the recess 31, whereas the gas flow openings 30c and 30d are located outside the recess 31.

The first resin frame 40 is a thick insulating plate member of a thermosetting resin (for example, a phenol resin) and has a thickness of several to ten-odd times as much as the thickness of the first separator 30. The thickness of the first resin frame 40 is set to ensure a sufficient gas flow rate in the hydrogen flow path 33 defined by the first separator 30 and the first resin frame 40 for the efficient electrochemical reaction of hydrogen with oxygen. The first resin frame 40 is located between the anode 52 of the MEA 50 and the first separator 30 and has an MEA mounting hole 41 for receiving the MEA 50 therein, gas flow openings 40a to 40d corresponding to the gas flow openings 30a to 30d, and cooling water flow openings 40e and 40f corresponding to the cooling water flow openings 30e and 30f. The MEA mounting hole 41 has a step formed along its circumference. The periphery of the MEA 50 received in the MEA mounting hole 41 is fastened to the step of the MEA mounting hole 41 via an adhesive. The first resin frame 40 and the first separator 30 are bonded to each other via a seal layer S1 (see an enlarged view in the circle of FIG. 1), except the recess 31, the respective gas and cooling water flow openings 30a to 30f and 40a to 40f, and the MEA mounting hole 41.

Like the first resin frame 40, the second resin frame 60 is a thick insulating plate member of the thermosetting resin (for example, the phenol resin) and has the thickness of several to ten-odd times as much as the thickness of the first separator 30. The thickness of the second resin frame 60 is set to ensure a sufficient gas flow rate in an air flow path 73, which is defined by the second separator 70 and the second resin frame 60, for the efficient electrochemical reaction of hydrogen with oxygen. The second resin frame 60 is located between the cathode 53 of the MEA 50 and the second separator 70 and has an MEA mounting hole 61 for receiving the MEA 50 therein, gas flow openings 60a to 60d corresponding to the gas flow openings 30a to 30d, and cooling water flow openings 60e and 60f corresponding to the cooling water flow openings 30e and 30f. The MEA mounting hole 61 has a step formed along its circumference. The periphery of the MEA 50 received in the MEA mounting hole 61 is fastened to the step of the MEA mounting hole 61 via the adhesive. The first and the second resin frames 40 and 60 are thick-walled to function as structural materials of giving the sufficient strength to the fuel cell 20 and are made of the insulating material to prevent a short circuit between the first separator 30 and the second separator 70.

Like the first separator 30, the second separator 70 is a thin metal plate member, for example, a nickel-plated stainless thin plate. A recess 71 is formed in a lower face of the second separator 70 or a plane facing the cathode 53 of the MEA 50 (see FIG. 4(b)). The recess 71 has the air flow path 73 to allow passage of the air. A serpentine cooling water flow path 77 is formed in an upper face of the second separator 70 (see FIG. 4(a)). The second separator 70 has gas flow openings 70a to 70d formed at its four corners. The gas flow openings 70c and 70d are located inside the recess 71, whereas the gas flow openings 70a and 70b are located outside the recess 71. A cooling water flow opening 70e is provided on one end of the cooling water flow path 77, while a cooling water flow opening 70f is provided on the other end of the cooling water flow path 77. The second resin frame 60 and the second separator 70 are bonded to each other via a seal layer S2 (see the enlarged view in the circle of FIG. 1), except the recess 71, the respective gas and cooling water flow openings 60a to 60f and 70a to 70f, and the MEA mounting hole 61. The second separator 70 in one fuel cell 20 is also bonded to the first separator 30 in an adjacent fuel cell 20 via a seal layer S4 (see the enlarged view in the circle of FIG. 1), except the cooling water flow path 77 and the respective gas and cooling water flow openings 30a to 30f and 70a to 70f.

The hydrogen supply manifold M1 is a cylindrical hollow space formed by connection of the gas flow opening 30a of the first separator 30, the gas flow opening 40a of the first resin frame 40, the gas flow opening 60a of the second resin frame 60, and the gas flow opening 70a of the second separator 70 in the laminating direction of the fuel cell stack 10. The hydrogen exhaust manifold M2 is a cylindrical hollow space formed by connection of the gas flow opening 30b of the first separator 30, the gas flow opening 40b of the first resin frame 40, the gas flow opening 60b of the second resin frame 60, and the gas flow opening 70b of the second separator 70 in the laminating direction of the fuel cell stack 10. Hydrogen is supplied into the hydrogen supply manifold M1, flows through the hydrogen flow paths 33 formed in the respective fuel cells 20, and is discharged out of the hydrogen exhaust manifold M2. Seal layers of an adhesive (not shown) are provided around the respective openings to keep the gas tightness of the respective manifolds M1 and M2 and prevent leakage of hydrogen.

The air supply manifold M3 is a cylindrical hollow space formed by connection of the gas flow opening 30c of the first separator 30, the gas flow opening 40c of the first resin frame 40, the gas flow opening 60c of the second resin frame 60, and the gas flow opening 70c of the second separator 70 in the laminating direction of the fuel cell stack 10. The air exhaust manifold M4 is a cylindrical hollow space formed by connection of the gas flow opening 30d of the first separator 30, the gas flow opening 40d of the first resin frame 40, the gas flow opening 60d of the second resin frame 60, and the gas flow opening 70d of the second separator 70 in the laminating direction of the fuel cell stack 10. The air is fed into the air supply manifold M3, flows through the air flow paths 73 formed in the respective fuel cells 20, and is emitted out of the air exhaust manifold M4. Seal layers of the adhesive (not shown) are provided around the respective openings to keep the air tightness of the respective manifolds M3 and M4 and prevent leakage of the air.

The cooling water supply manifold M5 is a cylindrical hollow space formed by connection of the cooling water flow opening 30e of the first separator 30, the cooling water flow opening 40e of the first resin frame 40, the cooling water flow opening 60e of the second resin frame 60, and the cooling water flow opening 70e of the second separator 70 in the laminating direction of the fuel cell stack 10. The cooling water discharge manifold M6 is a cylindrical hollow space formed by connection of the cooling water flow opening 30f of the first separator 30, the cooling water flow opening 40f of the first resin frame 40, the cooling water flow opening 60f of the second resin frame 60, and the cooling water flow opening 70f of the second separator 70 in the laminating direction of the fuel cell stack 10. The cooling water is introduced into the cooling water supply manifold M5, goes through the cooling water flow paths 77 formed in the respective fuel cells 20, and is flowed out of the cooling water discharge manifold M6. Seal layers of the adhesive (not shown) are provided around the respective openings to keep the liquid tightness of the respective manifolds M5 and M6 and prevent leakage of cooling water.

There is an inter-separator inclusion 80 of the layered structure between the first separator 30 and the second separator 70 as shown in the enlarged view in the circle of FIG. 1. The inter-separator inclusion 80 has a thickness of several mm and includes the first and the second resin frames 40 and 60 with the MEA 50 held therebetween, the seal layer S1 interposed between the first separator 30 and the first resin frame 40, the seal layer S2 interposed between the second separator 70 and the second resin frame 60, and a seal layer S3 interposed between the first resin frame 40 and the second resin frame 60. An optically readable barcode 24 is formed by laser irradiation in an information recording area 22 over the first resin frame 40, the seal layer S3, and the second resin frame 60 in an exposed outer face of the inter-separator inclusion 80. The barcode 24 is marked after assembly of the fuel cell 20. A code number of each barcode 24 is correlated to fuel cell-specific information stored in a hard disk of a computer (not shown). In response to input of the barcode 24 into the computer by a barcode reader (not shown), the fuel cell-specific information correlated to the code number of the input barcode 24 is retrieved and shown on a display of the computer (not shown). Typical examples of the fuel cell-specific information include the date of manufacture of the fuel cell 20, the respective press forming machines used for manufacturing the first separator 30 and the second separator 70 in the fuel cell 20, the respective dates of manufacture and the respective lot numbers of the first and the second separators 30 and 70, the respective dates of manufacture and the respective lot numbers of the first and the second resin frames 40 and 60, and the date of manufacture and the lot number of the MEA 50.

In the structure of the fuel cell 20 of the embodiment, the barcode 24 is marked on the exposed outer face of the inter-separator inclusion 80, which has the greater thickness and the greater flexibility than those of the first separator 30 and the second separator 70. The barcode 24 is thus readily provided and is readily scanned, regardless of the thicknesses and the materials of the first separator 30 and the second separator 70. The fuel cell 20 of the embodiment has the thin-walled first and second separators 30 and 70 and uses the thick-walled first and second resin frames 40 and 60 in the inter-separator inclusion 80 as the structural materials. This arrangement enables the effective use of the side faces of the respective resin frames 40 and 60 for the information recording area 22. The first and the second separators 30 and 70 are the thin metal plate members. This arrangement desirably decreases the overall length of the fuel cell stack 10 in its laminating direction and attains the favorable size reduction, while reducing the resistance between the adjacent fuel cells 20 and improves the power generation efficiency. The less content of the metal with the low specific heat effectively prevents an abrupt decrease in temperature of the fuel cells 20 after a stop of the fuel cell stack 10 even in the cold environment, and does not require large energy for warm-up at a restart of the fuel cell stack 10. Two barcodes 24 respectively provided on two adjacent fuel cells 20 in the fuel cell stack 10 are separated by at least the second separator 70 in one fuel cell 20 and the first separator 30 in the adjacent fuel cell 20. This arrangement effectively prevents one barcode 24 from interfering with the scan of the adjacent barcode 24.

The embodiment discussed above is to be considered in all aspects as illustrative and not restrictive. There may be many modifications, changes, and alterations without departing from the scope or spirit of the main characteristics of the present invention. The scope and spirit of the present invention are indicated by the appended claims, rather than by the foregoing description.

For example, the fuel cell-specific information correlated to the code number of each barcode 24 may additionally include maintenance information on the maintenance or repair of the fuel cell 20 if any. These pieces of information may be only writable or rewritable.

The fuel cell 20 of the embodiment adopts the optically readable barcode 24. The code number of the barcode 24 may be expressed as a letter string to enable the human's visual recognition, may be expressed as a concavo-convex code pattern to enable the mechanical scan, may be recorded in a magnetic tape to enable the magnetic scan, or may be recorded in an IC chip to allow the electric scan. The barcode 24 may be applied as a label or may be printed in ink, instead of being formed by laser irradiation as in the embodiment. In the case of printing the barcode 24, it is preferable to print the barcode 24 in a distinctive color for easy discrimination from the color of the inter-separator inclusion 80.

In the fuel cell 20 of the embodiment, the fuel cell-specific information is correlated to the code number of the barcode 24. One possible modification may replace the barcode 24 with a two-dimensional barcode, a magnetic tape, an IC chip, or another equivalent recording medium and directly record the fuel cell-specific information in the recording medium. The recording medium may be designed to be only writable or rewritable.

In the structure of the fuel cell 20 of the embodiment, the seal layers S1, S2, and S3 are formed to fill the gaps between the adjacent members. In one modified structure of the fuel cell 20 shown in the sectional view of FIG. 5, a seal member 26 is provided to cover over an outer circumferential face of the inter-separator inclusion 80. Part of a side face of the seal member 26 is set for the information recording area 22. The seal member 26 covering over the outer circumferential face of the inter-separator inclusion 80 effectively keeps the gas tightness and the air tightness of the hydrogen flow paths and the air flow paths formed in the respective fuel cells 20. The side face of the seal member 26 is effectively used as the information recording area 22. The seal member 26 may also cover over the outer circumferential faces of the first and the second separators 30 and 70, in addition to the outer circumferential face of the inter-separator inclusion 80.

In the structure of the fuel cell 20 of the embodiment, the barcodes 24 are provided for all the fuel cells 20 included in the fuel cell stack 10. In one possible modification, the barcode 24 may be provided for only one fuel cell 20 and record fuel cell stack-specific information (for example, the output characteristic) on the fuel cell stack 10 as well as fuel cell-specific information on the respective fuel cells 20 of the fuel cell stack 10. In another possible modification, the fuel cells 20 included in the fuel cell stack 10 are divided into multiple groups. The barcode 24 may be provided for only one fuel cell 20 in each group and record fuel cell group-specific information (for example, the output characteristic) on each group of the fuel cells 20 as well as fuel cell-specific information on the respective fuel cells 20 included in the group.

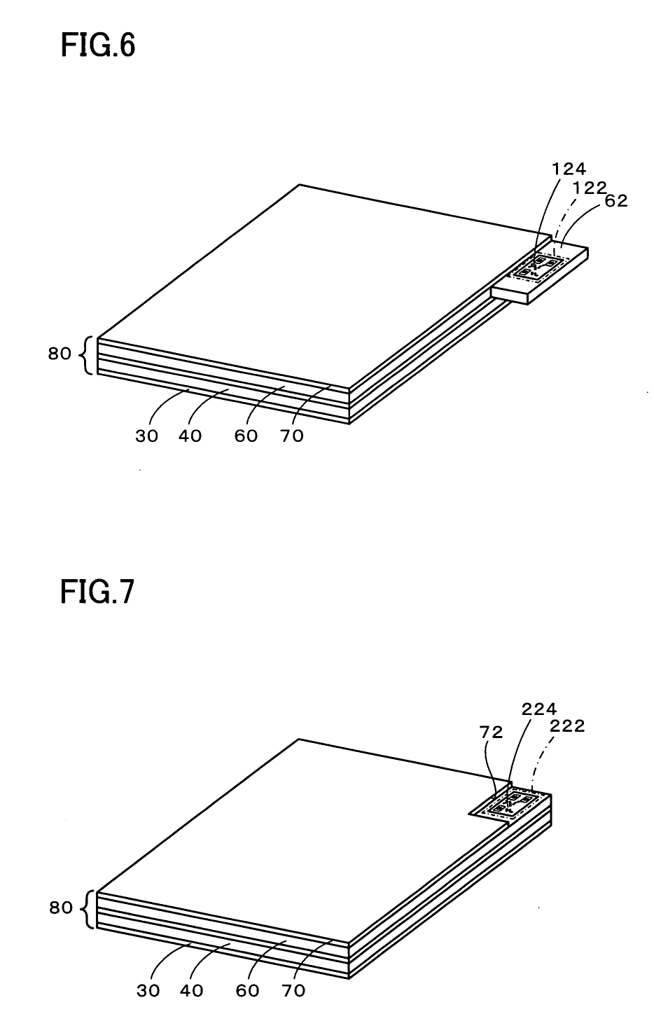

In the structure of the fuel cell 20 of the embodiment, the information recording area 22 is set on the side faces of the first and the second resin frames 40 and 60. In one modified example shown in FIG. 6, an information recording area 122 is set on a surface of a projection 62 protruded from the side face of the second resin frame 60. A two-dimensional code 124 storing fuel cell-specific information is provided in this information recording area 122. Since the projection 62 is protruded from the ends of the first and the second separators 30 and 70, the two-dimensional code 124 is exposed to the outside to be readily recognizable in the laminating direction. In another modified example shown in FIG. 7, the second separator 70 has a cutout 72 at one of its four corners to make an edge of the surface of the second resin frame 60 exposed. An information recording area 222 is set on this exposed edge surface, and a two-dimensional code 224 similar to the two-dimensional code 124 is provided in this information recording area 222. This arrangement also causes the two-dimensional code 224 to be exposed to the outside and readily recognizable in the laminating direction. In the modified example of FIG. 7, the second separator 70 has the cutout 72 at one of its four corners. This is, however, not essential. A cutout may be made by inwardly recessing one side between two corners of the second separator 70 to make part of the surface of the second resin frame 60 exposed. An information recording area is set on this exposed surface. The edge or side cutout structure desirably attains the total size reduction of the fuel cell stack, compared with the resin frame protrusion structure shown in FIG. 6. The two-dimensional code 124 or 224 may be prepared by forming convexes and concaves on the surface of the information recording area 122 or 222, may be printed directly on the information recording area 122 or 222, or may be applied as a printed label on the information recording area 122 or 222.

In the structure of the fuel cell 20 of the embodiment, the barcode 24 is provided on the exposed outer face of the inter-separator inclusion 80. In one modified structure, an IC tag having storage of a code number, which is equivalent to the code number of the barcode 24, is embedded in one of the first resin frame 40 and the second resin frame 60 in the inter-separator inclusion 80. The code number is read from the embedded IC tag by a reader and is input into the computer. Fuel cell-specific information corresponding to the code number is then retrieved and is shown on the display. The IC tag may be embedded in one of the seal layers S1 to S3, instead of the resin frame 40 or 60. The first and the second separators 30 and 70 are made of the metal material having the high electromagnetic shield and may thus have some trouble in wireless communication of the embedded IC chip. The first and the second resin frames 40 and 60 and the seal layers S1 to S3 are, on the other hand, made of the resin and rubber materials having the low electromagnetic shield and have no trouble in wireless communication of the embedded IC chip.

The present application claims priority from Japanese patent application No. 2005-117241 filed on Apr. 14, 2005, the contents of which are hereby incorporated by reference into this application.

### INDUSTRIAL APPLICABILITY

The technique of the invention is preferably applicable to vehicles, electronic devices, household equipment and facilities, and plant equipment and facilities equipped with fuel cells.

1. A fuel cell, comprising:
a pair of separators;
an inter-separator inclusion that is interposed between the pair of separators; and
an information recording element that is provided in the inter-separator inclusion and records information on the fuel cell.

2. The fuel cell in accordance with claim 1, wherein the inter-separator inclusion has a greater thickness than those of the separators.

3. The fuel cell in accordance with claim 1, wherein the inter-separator inclusion has a greater flexibility than those of the separators.

4. The fuel cell in accordance with claim 1, wherein the information recording element is set on an outer exposed surface of the inter-separator inclusion.

5. The fuel cell in accordance with claim 4, wherein the inter-separator inclusion has a frame member keeping a membrane electrode assembly, and the exposed surface includes at least a side face of the frame member.

6. The fuel cell in accordance with claim 4, wherein the inter-separator inclusion has a seal member arranged along an outer circumference of the inter-separator inclusion, and the exposed surface includes at least a side face of the seal member.

7. The fuel cell in accordance with claim 1, wherein the information recording element is embedded in the inter-separator inclusion.

8. The fuel cell in accordance with claim 7, wherein the inter-separator inclusion has a frame member keeping a membrane electrode assembly, and the information recording element is embedded in the frame member.

9. The fuel cell in accordance with claim 7, wherein the inter-separator inclusion has a seal member arranged along an outer circumference of the inter-separator inclusion, and the information recording element is embedded in the seal member.

10. The fuel cell in accordance with claim 1, wherein the information recording element records information visually recognizable by the human or information scannable in any of optical, magnetic, electric, and mechanical ways.

11. The fuel cell in accordance with claim 1, wherein the pair of separators are made of thin metal plates.

12. A fuel cell stack that is prepared by laminating multiple fuel cells,
wherein the multiple fuel cells include at least one fuel cell in accordance with claim 1.

13. A fuel cell stack that is prepared by laminating multiple fuel cells,
wherein the multiple fuel cells include two adjacent fuel cells in accordance with claim 1, and the respective information recording elements of the two adjacent fuel cells are separated by at least the separators of the two adjacent fuel cells.
